(19) United States
(12) Patent Application Publication
(10) Pub. No.: US 2006/0092479 A1
(43) Pub. Date: May 4, 2006

(54) Printing control apparatus and recording medium on which a program is recorded thereto for controlling a printing operation

(76) Inventor: Chiaki Dohi, Tokyo (JP)

Correspondence Address: DICKSTEIN SHAPIRO MORIN & OSHINSKY LLP, 2101 L Street, NW, Washington, DC, 20037, US

(21) Appl. No.: 11/257,319

(22) Filed: Oct. 25, 2005

(30) Foreign Application Priority Data
Oct. 29, 2004 (JP) 2004-316673

(51) Int. Cl. H04N 1/387

(52) U.S. Cl. 358/452

(57) ABSTRACT

The present invention discloses a printing control apparatus for controlling an operation for printing printing data generated from an application. The printing control apparatus includes a printing data file generating part for generating one or more printing data files for each page based on the printing data, (each printing data file including a page object), a page object displaying part for displaying the page object included in the printing data file, a page editing part for editing the page object displayed by the page object displaying part, and a printing data file editing part for editing the printing data file corresponding to the page object edited by the page editing part.

### BACKGROUND OF THE INVENTION

1. Field of the Invention

The present invention relates to a printing control apparatus for controlling a printing operation and a computer-readable recording medium on which a program for controlling a printing operation is recorded.

2. Description of the Related Art

In an exemplary case of performing a printing operation with a printing control apparatus controlled by a computer, an application (application software) creates printing data (e.g. data of a document input with, for example, a keyboard) on a screen of a monitor (display apparatus) and instructs the start of the printing operation in accordance with the input of, for example, a keyboard. Then, a printer driver (printer driver program) translates (converts) the printing data created by the application into a language comprehensible for a printer (printer language), and outputs the translated printing data to the printer. Accordingly, the printer prints the printing data. It is to be noted that the application is managed by an OS (Operating System).

Although a process of a program (e.g. application, printer driver) is actually executed by a CPU in accordance with the program, the process is described as being executed by the program for the sake of convenience.

The above-described printing control apparatus, however, has the following problems (1) and (2).

(1) Page-by-page page editing process (e.g., changing the order of pages, inserting a blank page between pages) of the printing data page-by-page can only be performed before the printing operation. That is, once the printing operation is started, the page editing process cannot be performed. In such a case, it is necessary to interrupt the printing operation in order to perform the page editing process. Furthermore, the page editing process cannot be performed, for example, in a case of printing the printing data in a combined state (i.e. printing multiple pages on a single sheet of paper) by selecting a printing condition for a combined printing mode.

(2) The layout of a printing page may be unsatisfactory due to the settings of a printing condition. For example, in a case where double-side printing or combined printing is selected for printing multiple pages on a single sheet of paper or on a reduced number of papers, continuous related pages may sometimes be printed on separate sheets of paper. FIG. 19 shows an example where the page for “Description of Fig.100” and the page for “Fig.100” are printed on two separate sheets of paper. In this case, a blank page (blank page data) is to be inserted in the page (intermediate data) corresponding to Page 2 in order to print the page for “Description of Fig.100” and the page for “Fig.100” on a single sheet of paper.

### SUMMARY OF THE INVENTION

It is a general object of the present invention to provide a printing control apparatus and a recording medium on which a program is recorded thereto that substantially obviates one or more of the problems caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by a printing control apparatus and a recording medium on which a program is recorded thereto particularly pointed out in the specification in such full, clear, concise, and exact terms as to enable a person having ordinary skill in the art to practice the invention.

To achieve these and other advantages and in accordance with the purpose of the invention, as embodied and broadly described herein, the invention provides a printing control apparatus for controlling an operation for printing printing data generated from an application, the printing control apparatus including: a printing data file generating part for generating one or more printing data files for each page based on the printing data, each printing data file including a page object; a page object displaying part for displaying the page object included in the printing data file; a page editing part for editing the page object displayed by the page object displaying part; and a printing data file editing part for editing the printing data file corresponding to the page object edited by the page editing part.

Furthermore, the present invention provides a recording medium on which a program for causing a computer to execute a method for controlling an operation for printing printing data generated from an application, the program including: a printing data file generating function for generating one or more printing data files for each page based on the printing data, each printing data file including a page object; a page object displaying function for displaying the page object included in the printing data file; a page editing function for editing the page object displayed by the page object displaying function; and a printing data file editing function for editing the printing data file corresponding to the page object edited by the page editing function.

Other objects and further features of the present invention will be apparent from the following detailed description when read in conjunction with the accompanying drawings.

### BRIEF DESCRIPTION OF THE DRAWINGS

FIG. 1 is a block diagram showing an exemplary software configuration of a host computer 10 according to an embodiment of the present invention;

FIG. 2 is a block diagram showing a connection relation of a printer system including a host computer 10 according to an embodiment of the present invention;

FIG. 3 is a block diagram showing an exemplary hardware configuration of a host computer 10 according to an embodiment of the present invention;

FIG. 4 is a flowchart showing an exemplary process of a host computer 10 according to an embodiment of the present invention for generating depiction data (page objects) for each page based on provisional printing data files (provisional printing data);

FIG. 5 is a flowchart showing another exemplary process of a host computer 10 according to an embodiment of the present invention when receiving a request for performing a page editing operation;

FIG. 6 is a flowchart showing another exemplary process of a host computer 10 according to an embodiment of the present invention when receiving a request for switching the page order;

FIG. 7 is a flowchart showing another exemplary process of a host computer 10 according to an embodiment of the present invention when receiving a request for inserting a blank page;

FIG. 8 is a flowchart showing an exemplary process (sub-routine) for generating blank page data according to an embodiment of the present invention;

FIG. 9A shows a page management table and a page index list generated by a page list managing part 109 according to an embodiment of the present invention;

FIG. 9B shows the page management table and the page index list of FIG. 9A that are changed by a page editing request according to an embodiment of the present invention;

FIG. 10 is an exemplary display screen of a display apparatus according to an embodiment of the present invention;

FIG. 11 is a flowchart showing an exemplary process of a host computer 10 according to an embodiment of the present invention for generating depiction data for each logical page based on provisional printing data files (provisional printing data);

FIG. 12 is a flowchart showing an exemplary process (sub-routine) for generating depiction data according to an embodiment of the present invention;

FIG. 13 is a flowchart showing another exemplary process of a host computer 10 according to an embodiment of the present invention when receiving a request for performing a page editing operation in logical page units;

FIG. 14A shows a page management table and a logical page index list generated by a page list managing part 109 according to an embodiment of the present invention;

FIG. 14B shows the page management table and the logical page index list of FIG. 14A that are changed by a page editing request according to an embodiment of the present invention;

FIG. 15 is another exemplary display screen of a display apparatus according to an embodiment of the present invention;

FIG. 16 is a flowchart showing an exemplary process of a host computer 10 according to an embodiment of the present invention for generating depiction data for each physical page based on provisional printing data files (provisional printing data);

FIG. 17 is a flowchart showing another exemplary process of a host computer 10 according to an embodiment of the present invention when receiving a request for performing a page editing operation in physical page units;

FIG. 18A shows a page management table, a logical/physical page index list, and a physical page index list generated by a page list managing part 109 according to an embodiment of the present invention;

FIG. 18B shows the page management table, the logical/physical page index list, and the physical page index list of FIG. 18A that are changed by a page editing request according to an embodiment of the present invention; and

FIG. 19 is an illustration for describing problems of a conventional art.

### DESCRIPTION OF THE PREFERRED EMBODIMENTS

In the following, embodiments of the present invention will be described with reference to the accompanying drawings.

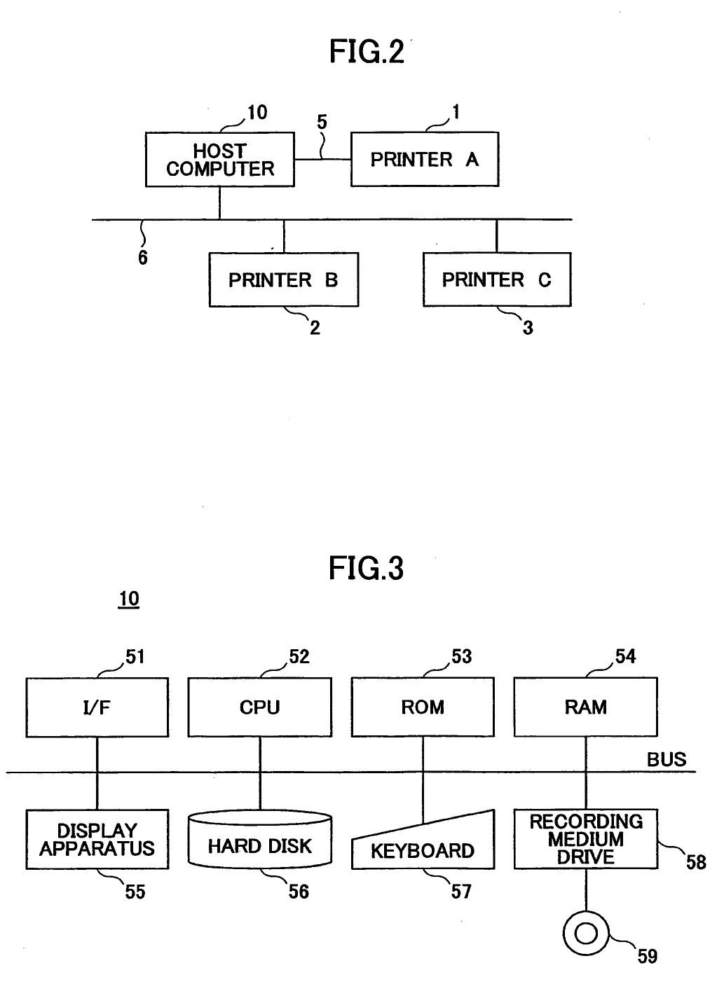

First, a printer system including a host computer 10 operable as a printing control apparatus according to an embodiment of the present invention is described with reference to FIG. 2. FIG. 2 is a block diagram showing an exemplary connection relation of the printer system.

The host computer 10 is connected to a printer 1 via a cable 5 and to printers 2 and 3 via a network 6 (e.g. LAN (Local Area Network)). The host computer 10 enables printing data of a given application 101 (not shown, described below) in the host computer 10 to be printed by the printers 1-3 via a printer driver (not shown, described below).

The host computer 10 is an information processing apparatus (e.g. PC (Personal Computer), workstation). The host computer 10 may be a client computer or a printer server. In a case of a printer server system, the client computer may be a Web client (e.g. Web server, Web browser) of the printer server (printing service).

Each of the printers 1-3 is an image forming apparatus having a printing function for forming (printing) an image on a sheet of paper based on the printing data from the host computer 10. Accordingly, the printers 1-3 are not limited to image forming apparatuses which only have a printing function (e.g., a laser printer, a LED printer, an inkjet printer), but also include an image forming apparatus having functions other than the printing function, for example, a copying function (e.g., a digital copying apparatus, a digital multi-function apparatus, a facsimile apparatus). The printers 1-3 may also include a printer server function.

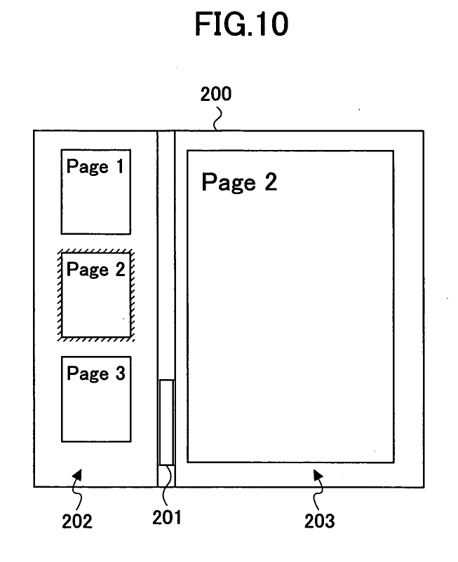

Next, an exemplary hardware configuration of the host computer 10 of FIG. 10 is described with reference to FIG. 3. FIG. 3 is a block diagram showing the exemplary hardware configuration.

The host computer 10 includes, for example, an interface (I/F) 51, a CPU (Central Processing Unit) 52, a ROM (Read Only Memory) 53, a RAM (Random Access Memory) 54, a display apparatus 55, a hard disk 56, a keyboard 57, and a recording medium drive 58.

The I/F 51 is a communication part for communicating with an outside apparatus, such as the printer 1 via the cable 5 (See FIG. 2) and/or the printers 2, 3 via the network 6 (See FIG. 2).

The CPU 52 is a Central Processing Unit for managing and controlling the entire host computer 10.

The ROM 53 is a Read Only Memory part (memory part) for storing a fixed program that is executed by the CPU 52.

The RAM 54 is a Random Access Memory part (memory part) used as a space into which a program that is being executed by the CPU 52 is stored for executing various processes.

The display apparatus 55 is a display part (e.g., CRT display, LCD display) for displaying, for example, various data and operations on a screen.

The hard disk 56 is a large amount memory part (memory part) for storing, for example, a program of the present invention and various data.

The keyboard 57 is an input part for allowing the user to input a variety of operational information. It is to be noted that the input part may include a pointing device such as a mouse.

The recording medium drive 58 is a recording/reproduction part for recording/reproducing data on/from a recording medium 59.

The recording medium 59 is a computer-readable recording medium that is mountable in the host computer 10 (e.g., MO, CD-R, CD-RW, DVD+R, DVD+RW, DVD-R, DVD-RW, DVD-RAM). The recording medium 59 is a recording medium onto which a program for performing a printing control operation of the present invention is recorded.

The user operates the keyboard 57 for enabling the CPU 52 of the host computer 10 to read out the program of the present invention from the recording medium 59 via the recording medium drive 58 and install the program into the hard disk 56.

When the power of the host computer 10 is switched on, the OS (Operating System), applications, and various programs (e.g., user interface) stored inside the hard disk 56 are read out according to a boot loader (boot program) in the ROM 53 and are installed in the RAM 54. The host computer 10 operates in accordance with the various applications and programs (applications and programs may be executed selectively according to circumstance) and uses the I/F 51 such that the various functions of the present invention described below (i.e. functions of a printing data file generating part, a page object displaying part, a page editing part, and a printing data file editing part (an associating part, a list generating part, and a list changing part, a printing data file changing part).

The program of the present invention is initiated when, for example, when the user inputs a printing command in the host computer 10 by using the keyboard 57. Then, the host computer 10 begins a printing control operation (printing process) in accordance with the program. The data for performing the printing control operation are stored in the RAM 54 or the hard disk 56 and are displayed on the display apparatus 55 according to necessity.

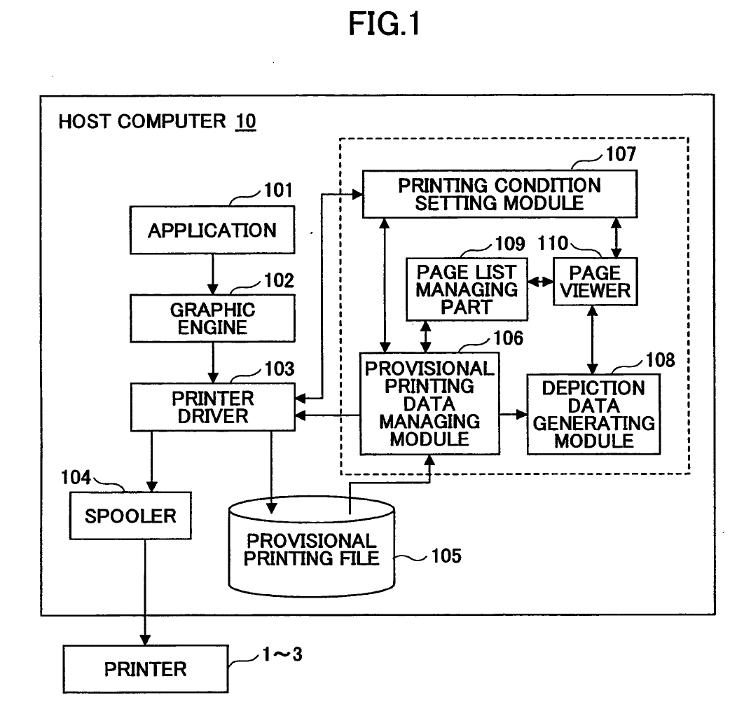

Next, an exemplary software configuration of the host computer 10 of FIG. 2 is described with reference to FIG. 1. FIG. 1 is a block diagram showing the exemplary software configuration.

In the host computer 10, an application 101 is that is operated with an OS (Operating System) such as Windows (Registered Trademark).

In a regular operation for printing depiction data (printing data) generated by the application 101 with an Operation System (e.g., Windows (Registered Trademark) in the host computer 10, a graphic engine 102 is used for depicting the depiction data generated by the application 101. The depiction data depicted by the graphic engine is sent to a printer driver 103.

The printer driver 103 converts the received depiction data into code data that is comprehensible for a printer (e.g., PDL (Page Description Language). The converted code data is stored in a spooler 104.

The spooler 104 transmits the stored code data to one of the printers 1-3 for printing the data.

In an OS (Operating System) such as Windows (Registered Trademark), the graphic engine 102 is referred to as a GDI (Graphic Device Interface) which is provided by the OS. In addition, the spooler 104 is also provided by the OS.

In another operation of the printing depicting data (printing data) generated by the application 101 in the host computer 10, the printer driver 103 converts the depiction data from the application 101 into provisional printing data (provisional data). The provisional printing data (provisional data) is data which is yet to be encoded as code data for the printer 1-3 (printer code data, for example, PDL) in a subsequent process. The provisional printing data (i.e. provisional printing data) is stored in the memory part of the host computer 10 (including the RAM 54, the hard disk 56, or the recording medium 59). The provisional printing data is stored in the form of provisional printing files (provisional data files) 105, in which each provisional printing file corresponds to a single page.

Furthermore, additional printing condition information is added to the provisional printing files (provisional data files) 105 stored in the memory part. The data including the provisional printing file 105 and the additional printing condition information (edited printing data) is sent back to the printer driver 103. The printer driver 103 converts the edited printing data to printer code data and outputs the code data to one of the printers 1-3. The printer 1-3, upon receiving the printer code data, prints the code data according to a predetermined printing condition (e.g. combined printing mode, double-side printing mode).

In the host computer 10 according to an embodiment of the present invention, the provisional printing data stored as the provisional printing files 105 in the memory part are managed by a provisional printing data managing module 106. A printing condition setting module 107 receives the provisional printing data from the provisional printing data managing module 106. The provisional printing data setting module 107 exchanges information between the printer driver 103 for generating achievable and consistent printing conditions and adds the printing conditions to the received provisional printing data. Then, the data including the provisional printing data added with the printing condition information is sent to the printer driver 103 and is printed by the printers 1-3. Alternatively, the data including the provisional printing data with the printing condition information added may be sent to the provisional printing condition data managing module 106. Then, the data received by the provisional printing condition data managing module 106 is sent to the printer driver 103 and is printed by the printer 1-3.

It is to be noted that the printing condition information includes various printing modes for allowing multiple printing data items to be printed and viewed on a single sheet of paper (e.g. combined printing mode, double-side printing mode, header printing mode, footer printing mode). The printing modes including the foregoing printing modes can be set beforehand by operating with, for example, the keyboard 57.

Next, the printing control process of the present invention (which is executed by the provisional printing data managing module 106, a depiction data generating module 108, a page list managing part 109, and a page viewer 110) is described.

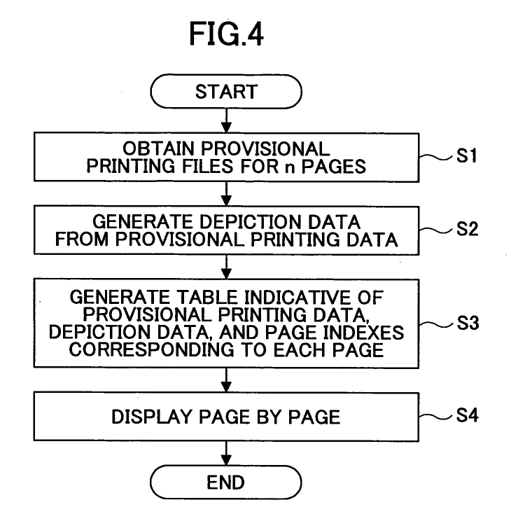

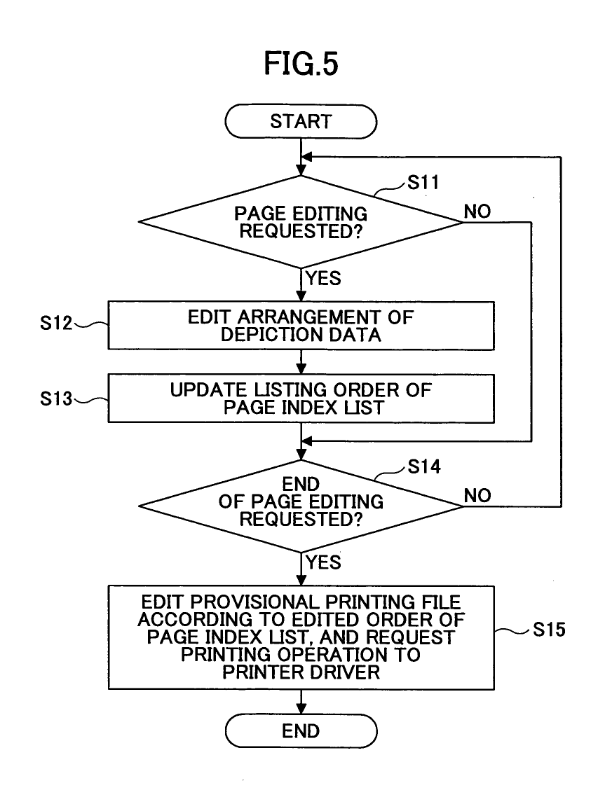

Six examples of the printing control process using the host computer 10 (Embodiments 1-6) are described with reference to FIGS. 4-18. It is to be noted that, although the provisional printing data are stored in the hard disk 56 in the embodiments described below, the data may alternatively be stored in the RAM 54 and/or the recording medium 59. It is to be noted that a further detailed description of the printing condition setting module 107 is omitted for the sake of convenience.

### First Embodiment

First, the printing control process using the host computer 10 according to the first embodiment of the present invention is described.

FIG. 4 is a flowchart showing a process of the host computer 10 for generating depiction data (page objects) corresponding to each page based on the provisional printing files 105 stored in the hard disk 56.

First, the printer driver 103 of the host computer 10 stores printing data (depiction data) from the application 101 into the hard disk 56 (in the form of provisional printing files (provisional printing data)).

After the provisional printing files are stored in the hard disk 56, a main routine (not shown) invokes the host computer 10 to start the process illustrated in FIG. 4. In Step S1, the provisional printing data managing module 106 obtains (reads out) a prescribed number of provisional printing data items included in the provisional printing files corresponding to each page. After “n” provisional printing data items (provisional printing data items for “n” pages) are obtained (recognized), “n” provisional printing data items are sent to the printing condition setting module 107, the depiction data generating module 108, and the page list managing part 109.

In Step S2, when the depiction data generating module 108 receives the provisional printing data items for “n” pages, the depiction data generating module 108 generates depiction data items of “n” pages in correspondence with the received provisional printing data items.

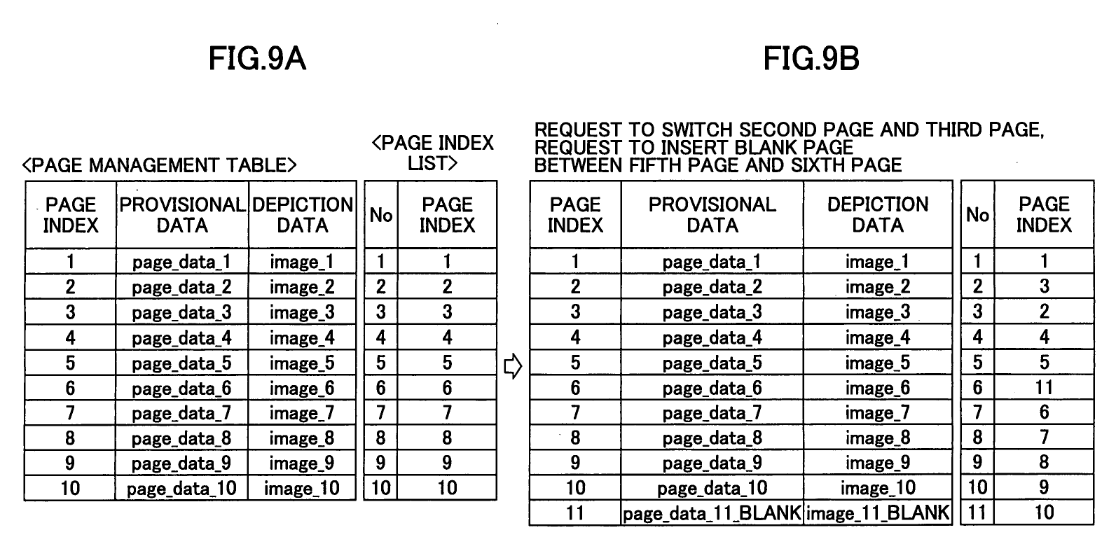

In Step S3, when the page list generating part 109 obtains the “n” provisional printing data items and the depiction data items corresponding to the “n” provisional printing data items, the page list generating part 109 associates the “n” provisional printing data items, the corresponding depiction data items, and pages indexes and generates a page management table indicative of the provisional printing data items, the depiction data items, and the page indexes for managing the provisional printing data items and the depiction data items page by page. Furthermore, the page list generating part 109 generates a page index list listing the page indexes. An example of the page management table and the page index list is illustrated in FIG. 9A.

In Step S4, a page viewer 110 displays the depiction data items on the display apparatus 55 (See FIG. 3) in a manner in which the depiction data items are arranged in a page by page order. An example of the screen 200 on which the depiction data items are displayed is illustrated in FIG. 10.

In a left-side screen part 202 of the screen 200 shown in FIG. 10, the depiction data items (page images) for all the pages can be viewed page by page by vertically moving a scroll key 201 with a pointing device (not shown). Furthermore, in a right-side screen part 203 of the screen 200, an enlarged view of a given depiction data item can be displayed by operating the pointing device (not shown) for selecting one of the depiction data items (in this example, the depiction data item corresponding to Page 2) that are displayed on the left-side screen part 202. The enlarged depiction data item can be edited by operating with the keyboard 57 or the pointing device (not shown).

FIG. 5 is a flowchart of a process conducted when the host computer 10 receives a request for performing a page editing operation.

First, a main routine (not shown) invokes the host computer 10 to start the process illustrated in FIG. 5.

In Step S11, the user uses the keyboard 57 for requesting the page editing operation in the page viewer 110. When the page editing operation is requested by the user (Yes in Step S11), the process proceeds to Step S12. In Step S12, the arrangement of the depiction data items (page objects) corresponding to each page are edited (changed).

In Step S13, the page list managing part 109 updates (changes) the order of the page indexes listed in the page index list in accordance with the edited (changed) arrangement of the depiction data items.

When the user requests the host computer 10 to end the page editing operation by using the keyboard 57 (Yes in Step S14), the process proceed to Step S15. In Step S15, the provisional printing data managing module 106 changes (edits) the configuration of the provisional printing files (technically, the provisional printing data obtained from the printing condition setting module 107 is changed) in accordance with the updated order of the page indexes listed in the page index list (i.e. changes the provisional printing files in accordance with the edited (changed) arrangement of the depiction data items), sends the edited provisional printing data of the provisional printing files to the printer driver 103, and requests the printer driver 103 to instruct one of the printers 1-3 to print the edited provisional printing data.

When the host computer 10 receives another page editing request in Step S11, the process is repeated.

In the first embodiment of the present invention, provisional printing data (provisional printing files) are generated page by page based on the printing data from the application 101, and the depiction data items (page objects) corresponding to the provisional printing data (provisional printing files) are displayed page by page on the display apparatus 55. This allows the user to visually confirm the layout of a page on which the printing data are printed and edit the depiction data item displayed on the display apparatus 55. Thus, when the depiction data item (page object) is edited, the provisional printing data corresponding to the edited the depiction data can be edited. Accordingly, a page editing process can be performed in the middle of performing printing control (printing process) based on the printing data from the application 101.

### Second Embodiment

Next, a printing control process using the host computer 10 according to the second embodiment of the present invention is described. Although the process shown in FIG. 4 is performed also in the printing control process of the second embodiment of the present invention, further description of the process shown in FIG. 4 is omitted.

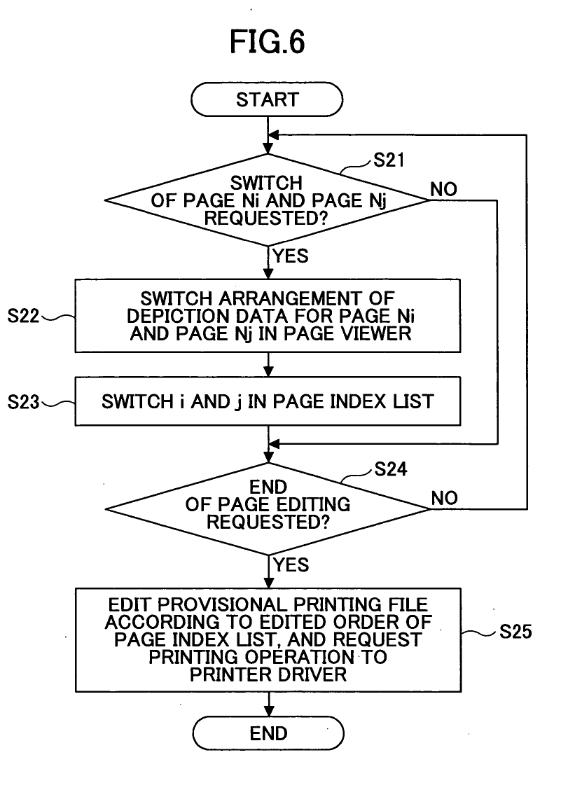

FIG. 6 is a flowchart showing a process where the host computer 10 receives a request for switching the order of the pages (switching operation).

The main routine (not shown) invokes the host computer 10 to start the process illustrated in FIG. 6. In Step S21, the user uses the keyboard 57 for requesting the order of the pages to be switched (in this example, a request for switching the order of page Ni and page Nj) to the page viewer 110. When the order of the pages is requested to be switched by the user (Yes in Step S21), the process proceeds to Step S22. In Step S22, the order (arrangement) between the depiction data item (page object) corresponding to page Ni and the depiction data item (page object) corresponding to page Nj is switched.

In Step S23, the page list managing part 109 switches the order of the page index “i” and “j” listed in the page index list in accordance with the switching of the order of the page objects between pages Ni and Nj. For example, as shown in FIG. 9B, the page index “2” and “3” are switched.

When the user requests the host computer 10 to end the switching operation by using the keyboard 57 (Yes in Step S24), the process proceed to Step S25. In Step S25, the provisional printing data managing module 106 changes (edits) the configuration of the provisional printing files in accordance with the updated order of the page indexes listed in the page index list, sends the edited provisional printing data of the provisional printing files to the printer driver 103, and requests the printer driver 103 to instruct one of the printers 1-3 to print the edited provisional printing data.

When the host computer 10 receives another page switching request in Step S21, the process is repeated.

Although the order of one page is switched with the order of another page in the switching operation described in the second embodiment of the present invention, the order of multiple pages may be switched with the order of other multiple pages.

In the second embodiment of the present invention, provisional printing data (provisional printing files) is generated page by page based on the printing data from the application 101, and the depiction data items (page objects) corresponding to the provisional printing data (provisional printing files) are displayed page by page on the display apparatus 55. This allows the user to visually confirm the layout of a page to which the printing data is printed and switch (edit) the order of the depiction data item (page object) displayed on the display apparatus 55. Thus, when the order of the depiction data item (page object) is switched, the order of the provisional printing data file corresponding to the switched depiction data item (page object) can be switched. Accordingly, a page editing process (in this case, a page switching operation) can be performed in the middle of performing printing control (printing process) based on the printing data from the application 101.

### Third Embodiment

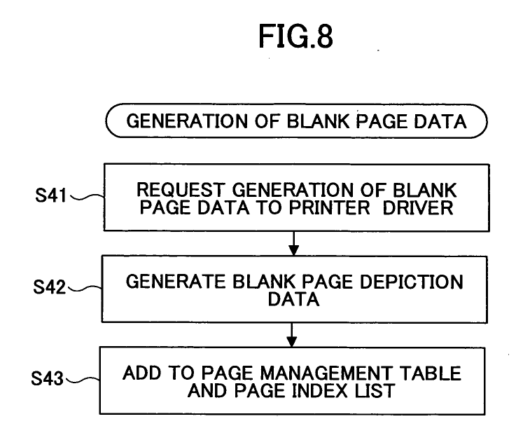

Next, a printing control process using the host computer 10 according to the third embodiment of the present invention is described. Although the process shown in FIG. 4 is performed also in the printing control process of the third embodiment of the present invention, further description of the process shown in FIG. 4 is omitted. FIG. 6 is a flowchart showing a process where the host computer 10 receives a request for inserting a blank page (blank page inserting operation). FIG. 8 is a flowchart showing a process (sub-routine) for generating blank page data.

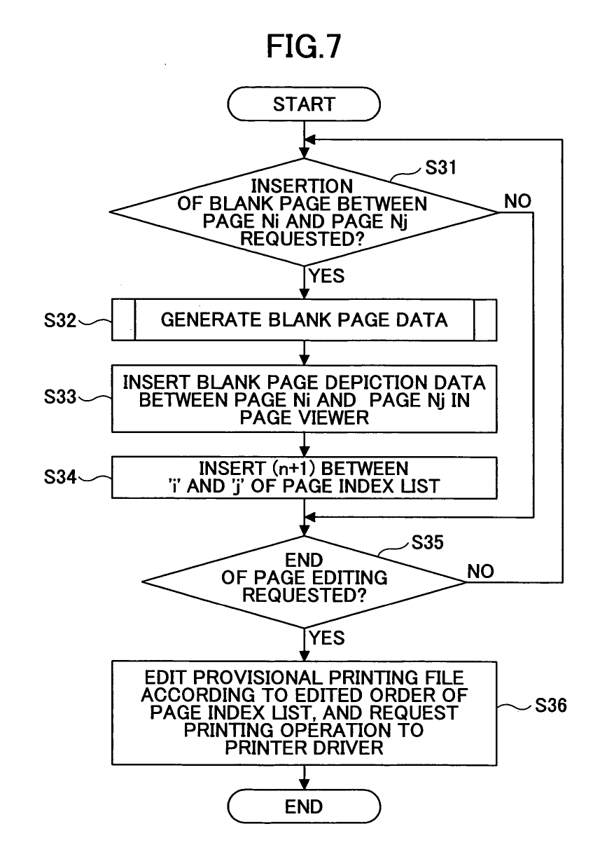

The main routine (not shown) invokes the host computer 10 to start the process illustrated in FIG. 7. In Step S31, the user uses the keyboard 57 for requesting a blank page to be inserted (in this example, a request for inserting a blank page between Page Ni (Order No. “i”) and Page Nj (Order No. “j”)) in the page viewer 110. When the insertion of the blank page is requested by the user (Yes in Step S31), the process proceeds to a blank page data generating process of Step S32.

The blank page data generating process is described in detail with reference to FIG. 8. In Step S41, the provisional printing data managing module 106 requests the printer driver 103 to generate blank page data.

Then, the printer driver 103, upon receiving the request, generates blank page data (i.e. provisional printing data (provisional printing data file) of a blank page). The generated blank page data is sent to the depiction data generating module 108 and the page list managing part 109 via the provisional printing data managing module 106.

In Step S42, the depiction data generating module 108 generates depiction data (page object) of a blank page based on the provisional printing data of the blank page received from the printer driver 103 via the provisional printing data managing module 106.

In Step S43, the page list managing part 109 associates a new page index with respect to the provisional printing data of the blank page (received from the printer driver 103 via the provisional printing data managing module 106) and the depiction data of the blank page (generated by the depiction data generating module 108). The provisional printing data of the blank page and the depiction data of the blank page corresponding to the new page index are added to the page management table. The new page index is added to the page index list. For example, as shown in FIG. 9B, the provisional printing data of the blank page and the depiction data of the blank page are added in correspondence with Page Index “11” in the page management table, and Page Index No. 11 is added to the page index list.

Then, returning to the process illustrated in FIG. 7, the depiction data of the blank page (generated by the depiction data generating module 108) is inserted between the depiction data of Page Ni and the depiction data of Page Nj in the page viewer (Step S33).

In Step S34, the page list managing part 109 inserts (n+m) (m=1, 2, 3, . . . ), which is the page index of the blank page between the page index “i” and the page index “j”, in accordance with the insertion of the depiction data of the blank page (update operation). For example, as shown in FIG. 9B, No. 11 is inserted (moved) between No. 5 and No. 6.

Then, when the user requests the host computer 10 to end the blank page inserting operation by using the keyboard 57 (Yes in Step S35), the process proceed to Step S36. In Step S36, the provisional printing data managing module 106 changes (edits) the configuration of the provisional printing files in accordance with the updated order of the page indexes listed in the page index list, sends the edited provisional printing data of the provisional printing files to the printer driver 103, and requests the printer driver 103 to instruct one of the printers 1-3 to print the edited provisional printing data.

When the host computer 10 receives another blank page insertion request in Step S31, the process is repeated.

Although a single blank page is inserted in the blank page inserting operation described in the third embodiment of the present invention, plural blank pages may be inserted.

In the third embodiment of the present invention, provisional printing data (provisional printing files) is generated page by page based on the printing data from the application 101, and the depiction data items (page objects) corresponding to the provisional printing data (provisional printing files) are displayed page by page on the display apparatus 55. This allows the user to visually confirm the layout of a page to which the printing data is printed and insert depiction data (page object) of a blank page displayed on the display apparatus 55. Thus, when the depiction data (page object) of the blank page is inserted, a provisional printing data file corresponding to the inserted depiction data of the blank page can be inserted. Accordingly, a page editing process (in this case, a blank page inserting operation) can be performed in the middle of performing printing control (printing process) based on the printing data from the application 101.

### Fourth Embodiment

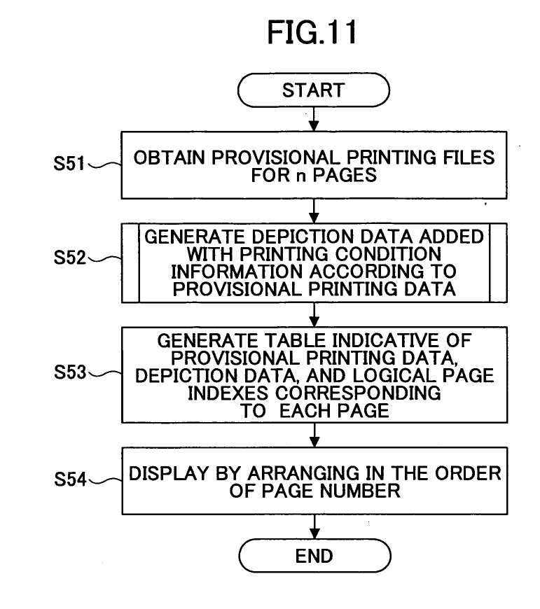

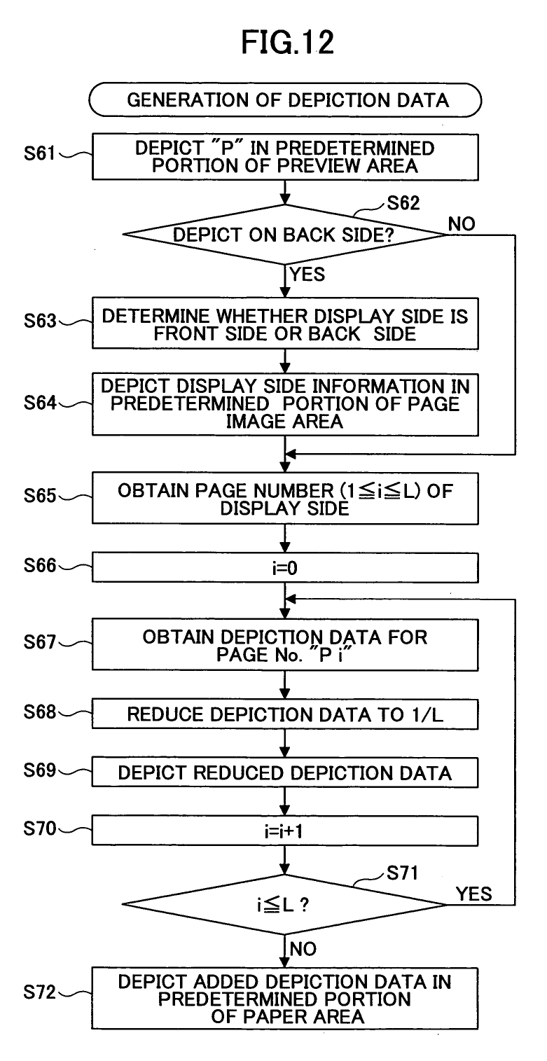

Next, a printing control process using the host computer 10 according to the fourth embodiment of the present invention is described. FIG. 11 is a flowchart showing a process performed by the host computer 10 for generating depiction data of each logical page based on provisional printing data. FIG. 12 is a flowchart showing a process (sub-routine) for generating the depiction data.

After provisional printing data files are stored in the hard disk 56, the main routine (not shown) invokes the host computer 10 to start the process illustrated in FIG. 11. In Step S51, the provisional printing data module 106 obtains provisional printing data files (provisional printing data) from the hard disk 56. After obtaining provisional printing data files for “n” pages, the provisional printing data module 106 sends the provisional printing data files (provisional printing data) to the printing condition setting module 107, the depiction data generating module 108, and the page list managing part 109.

In Step S62, the depiction data generating module 108, upon receiving the provisional printing data for “n” pages added with printing condition information that is set beforehand by the printing condition setting module 107, generates depiction data for “n” pages based on the received provisional data (depiction data generating operation).

The depiction data generating operation is described with reference to FIG. 12. In Step S61, a paper number “P” is depicted in a predetermined portion in a preview area in a video RAM (not shown) serving to determined the paper number “P” that is to be depicted (displayed). Then, in Step S62, it is determined whether a paper number “P” is to be depicted also on a back side of the paper. In a case where it is determined that the paper number “P” is not to be depicted on the back side (Yes in Step S62), the process proceeds to Step S65. In a case where it is determined that the paper number “P” is to be depicted also on the back side (No in Step S62), the process proceeds to Step S63. In Step S63, it is determined whether the display side is the front side or the back side. In Step S64, side information (front side/back side) is depicted in a predetermined portion of a page image area in the video RAM (not shown).

In Step S65, a page number Pi (1≦i≦L), which is to be displayed on the display side of the screen of the display apparatus 55, is obtained.

Next, in Step S66, “i” is reset to value “0”. In Step S67, depiction data (page object) corresponding to Page No. Pi is obtained from the provisional printing data managing module 106. In Step S68, the obtained depiction data is size-reduced to a size of 1/L. In Step S69, the sized-reduced depiction data is depicted on a paper area of a page object area in the video RAM in accordance with depiction position information of the depiction data.

Then, in Step S70, “i” is incremented (+1). In Step S71, it is determined whether the relation between “i” and “L” satisfies a relation of i≦L. The process proceeds to Step S72 when the relation of i≦L is satisfied. In Step S72, added depiction data is depicted in a predetermined portion of a paper area of a page object area in the video RAM (not shown).

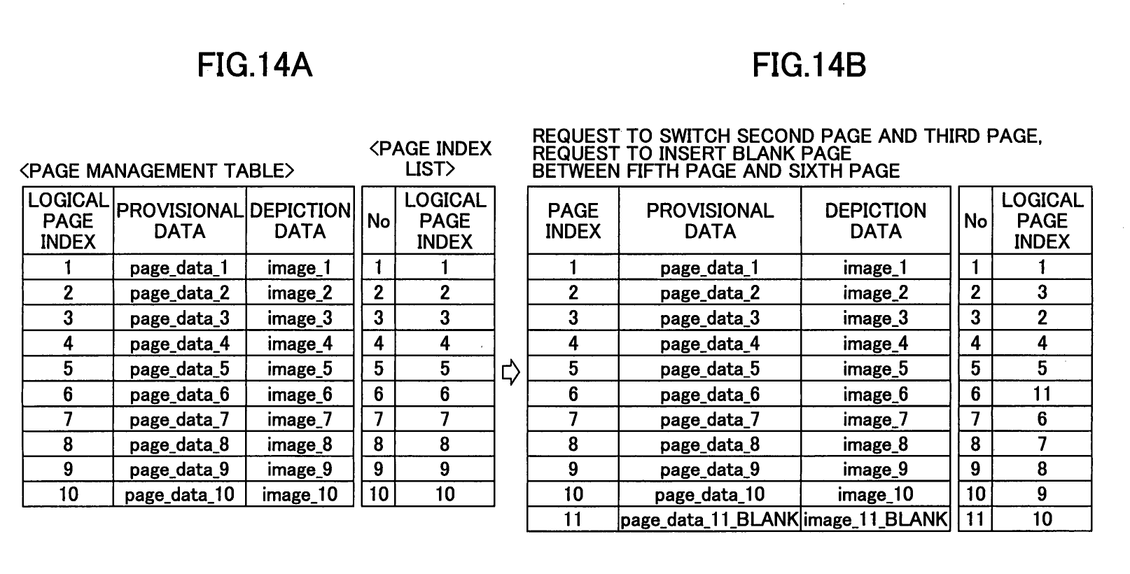

Then, returning to the process illustrated in FIG. 11, the page list managing part 109 associates logical page indexes with respect to the provisional printing data files (provisional printing data) received from the provisional printing data managing module 106 and the depiction data generated in correspondence with each page according to the provisional printing data. Accordingly, the page list managing part 109 generates a page management table for managing the provisional printing data and the depiction data in correspondence with each page index, and a logical page index list listing the logical page indexes. An example of the page management table and the logical page index list is shown in FIG. 14A.

In this example, one type of printing mode (printing condition) is to print printing data of a single page on a single piece of paper. The other type of printing mode (printing condition) is to print printing data of multiple pages on a single piece of paper. In this example, a physical page refers to a page on which printing data of a single piece of paper is printed. Furthermore, in a case of employing the other type of printing mode, a logical page refers to a page on which printing data of one or more pages is printed.

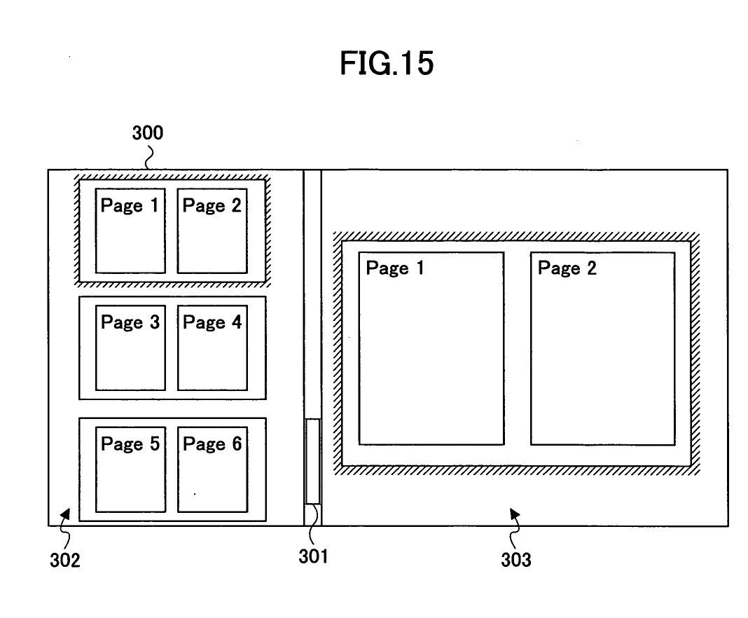

With reference to a display screen 300 shown in FIG. 15, the depiction data (page objects) for all the pages can be viewed physical page by physical page (in physical page units) in a left-side screen part 302 of the screen 300 by vertically moving a scroll key 301 with a pointing device (not shown). Furthermore, in a right-side screen part 303 of the screen 300, an enlarged view of a given depiction data (page object) for two pages can be displayed by operating the pointing device (not shown) for selecting the depiction data for two pages (in this example, a single piece of paper including depiction data corresponding to Pages 1 and 2) that are displayed on the left-side screen part 302. The enlarged depiction data can be edited by operating with the keyboard 57 or the pointing device (not shown).

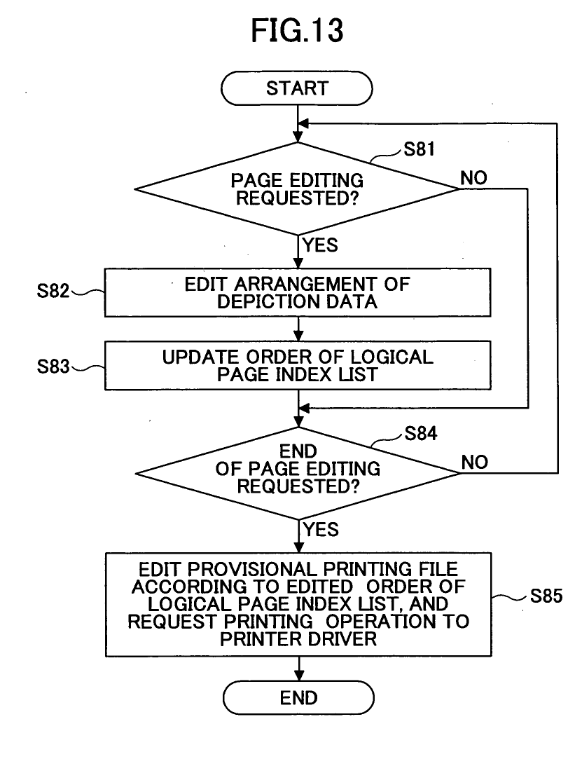

FIG. 13 is a flowchart of a process conducted when the host computer 10 receives a request for performing a page editing operation in logical page units (logical page by logical page).

First, a main routine (not shown) invokes the host computer 10 to start the process illustrated in FIG. 13.

In Step S81, the user uses the keyboard 57 for requesting the page editing operation in the page viewer 110 in logical page units. When the page editing operation is requested by the user (Yes in Step S81), the process proceeds to Step S82. In Step S82, the arrangement of the depiction data items (page objects) corresponding to each logical page are edited (changed).

In Step S83, the page list managing part 109 updates (changes) the order of the logical page indexes listed in the page index list in accordance with the edited (changed) arrangement of the depiction data items.

For example, in a case where the page editing requests is to switch the order of the logical pages (in this example, logical page Ni and logical page Nj), the order (arrangement) between the depiction data of the logical page Ni and the depiction data of the logical page Nj is switched in the page viewer 110. The page list managing part 109 switches the order between the logical page indexes for “i” and “j” in the logical page index list in accordance with the switching of the depiction data of the logical pages Ni and Nj. For example, as shown in FIG. 14b, the pages “2” and “3” are switched.

Then, when the user requests the host computer 10 to end the page editing operation by using the keyboard 57 (Yes in Step S84), the process proceeds to Step S85. In Step S85, the provisional printing data managing module 106 changes (edits) the configuration of the provisional printing files (technically, the provisional printing data obtained from the printing condition setting module 107 is changed) in accordance with the updated order of the logical page indexes listed in the logical page index list (i.e. changes the provisional printing files in accordance with the edited (changed) arrangement of the depiction data items), sends the edited provisional printing data of the provisional printing files to the printer driver 103, and requests the printer driver 103 to instruct one of the printers 1-3 to print the edited provisional printing data.

When the host computer 10 receives another page editing request for editing in logical page units in Step S81, the process is repeated.

In the fourth embodiment of the present invention, provisional printing data (provisional printing files) are generated logical page by logical page based on the printing data from the application 101, and the depiction data items (page objects) corresponding to the provisional printing data (provisional printing files) are displayed physical page by physical page (alternatively, displayed logical page by logical page) on the display apparatus 55. This allows the user to visually confirm the layout of a page on which the printing data are printed and edit the depiction data item displayed on the display apparatus 55. Thus, when the depiction data item (page object) is edited, the provisional printing data corresponding to the edited the depiction data can be edited. Accordingly, a page editing process can be performed in logical page units in the middle of performing printing control (printing process) based on the printing data from the application 101.

### Fifth Embodiment

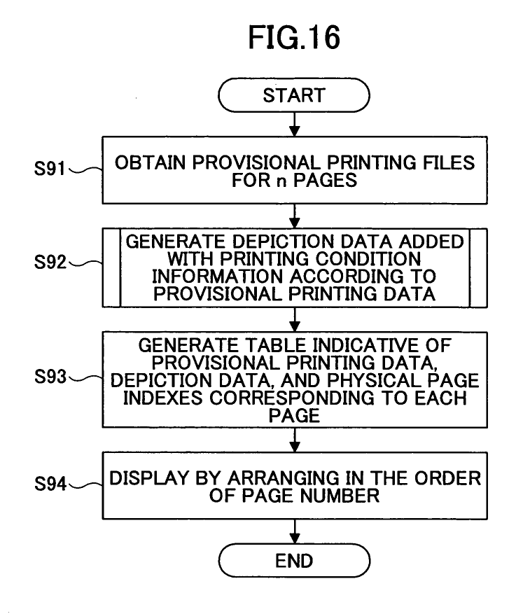

Next, a printing control process using the host computer 10 according to the fifth embodiment of the present invention is described. FIG. 16 is a flowchart showing a process performed by the host computer 10 for generating depiction data of each physical page based on provisional printing data.

After provisional printing data files are stored in the hard disk 56, the main routine (not shown) invokes the host computer 10 to start the process illustrated in FIG. 16. In Step S91, the provisional printing data module 106 obtains provisional printing data files (provisional printing data) from the hard disk 56. After obtaining provisional printing data files for “n” pages, the provisional printing data module 106 sends the provisional printing data files (provisional printing data) to the printing condition setting module 107, the depiction data generating module 108, and the page list managing part 109.

In Step S92, the depiction data generating module 108, upon receiving the provisional printing data for “n” pages added with printing condition information (e.g. printing mode information for printing printing data of multiple pages on a single piece of paper) that is set beforehand by the printing condition setting module 107, generates depiction data for “n” pages based on the received provisional data (depiction data generating operation). Since the depiction data generating operation is the same as that described with FIG. 12, further description thereof is omitted.

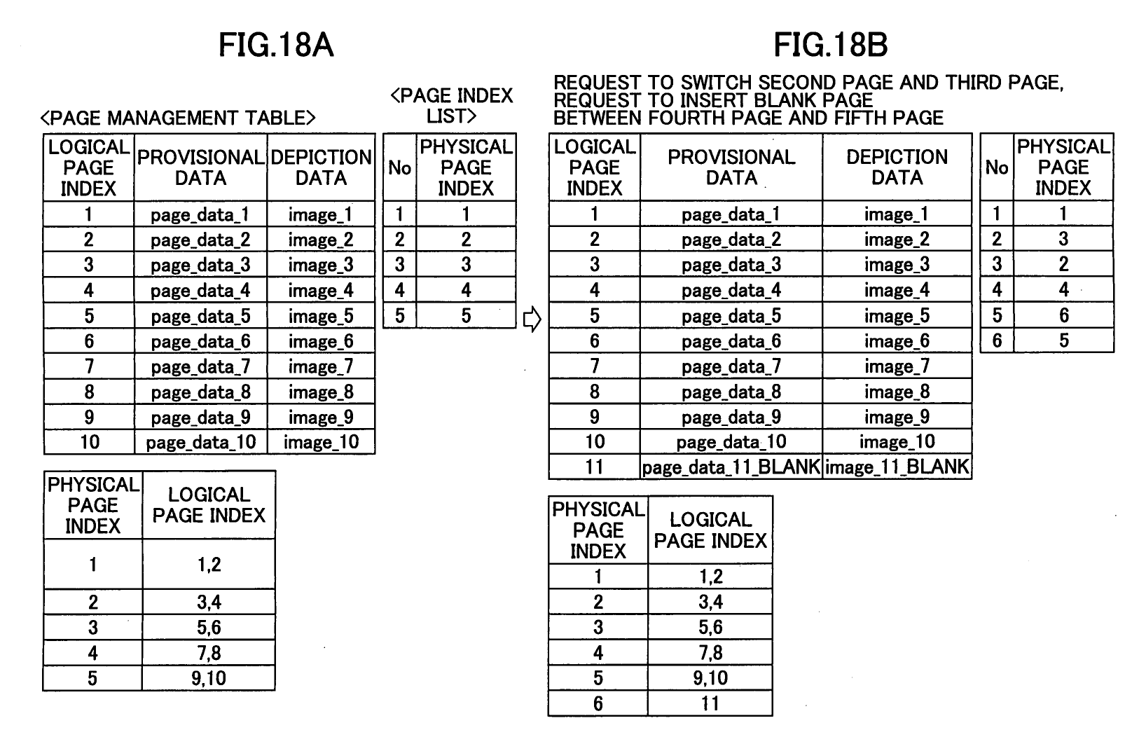

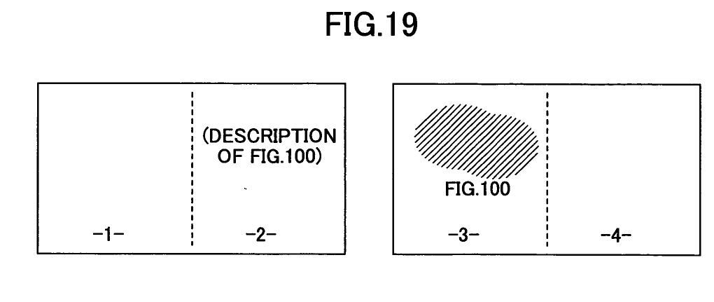

Then, in Step S93, the page list managing part 109 associates logical page indexes with respect to the provisional printing data files (provisional printing data) received from the provisional printing data managing module 106 and the depiction data generated in correspondence with each page according to the provisional printing data. Accordingly, the page list managing part 109 generates a page management table for managing the provisional printing data and the depiction data in correspondence with each logical page index, a logical/physical page index list which associates the logical page indexes with physical page indexes, and a physical page index list listing the physical page indexes. An example of the page management table, the logical/physical page index list and the physical page index list is shown in FIG. 18A.

In Step S94, the page viewer 110 displays the depiction data for each logical page in a manner arranged according to the order of the page number “P” (see FIG. 15).

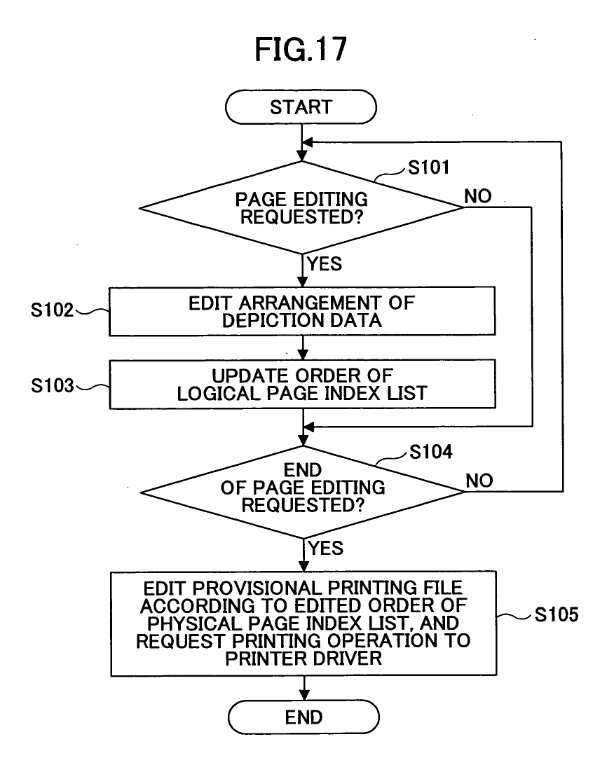

FIG. 17 is a flowchart of a process conducted when the host computer 10 receives a request for performing a page editing operation in physical page units (physical page by physical page).

First, a main routine (not shown) invokes the host computer 10 to start the process illustrated in FIG. 17.

In Step S101, the user uses the keyboard 57 for requesting the page editing operation in the page viewer 110 in physical page units. When the page editing operation is requested by the user (Yes in Step S101), the process proceeds to Step S102. In Step S102, the arrangement of the depiction data items (page objects) corresponding to each physical page are edited (changed).

In Step S103, the page list managing part 109 updates (changes) the order of the physical page indexes listed in the physical page index list in accordance with the edited (changed) arrangement of the depiction data items.

For example, in a case where the page editing requests is to switch the order of the physical pages (in this example, physical page Ni and physical page Nj), the order (arrangement) between the depiction data of the physical page Ni and the depiction data of the physical page Nj is switched in the page viewer 110. The page list managing part 109 switches the order between the physical page indexes for “i” and “j” in the physical page index list in accordance with the switching of the depiction data of the physical pages Ni and Nj. For example, as shown in FIG. 18b, the pages “2” and “3” are switched.

Then, when the user requests the host computer 10 to end the page editing operation by using the keyboard 57 (Yes in Step S104), the process proceeds to Step S105. In Step S105, the provisional printing data managing module 106 changes (edits) the configuration of the provisional printing files (technically, the provisional printing data obtained from the printing condition setting module 107 is changed) in accordance with the updated order of the physical page indexes listed in the physical page index list (i.e. changes the provisional printing files in accordance with the edited (changed) arrangement of the depiction data items), sends the edited provisional printing data of the provisional printing files to the printer driver 103, and requests the printer driver 103 to instruct one of the printers 1-3 to print the edited provisional printing data.

When the host computer 10 receives another page editing request for editing in physical page units in Step S101, the process is repeated.

In the fifth embodiment of the present invention, provisional printing data (provisional printing files) are generated logical page by logical page based on the printing data from the application 101, and the depiction data items (page objects) corresponding to the provisional printing data (provisional printing files) are displayed physical page by physical page on the display apparatus 55. This allows the user to visually confirm the layout of a page on which the printing data are printed and edit the depiction data item displayed on the display apparatus 55. Thus, when the depiction data item (page object) is edited, the provisional printing data corresponding to the edited the depiction data can be edited. Accordingly, even in a case where a printing operation under a printing condition of printing data of multiple pages on a single piece of a paper is requested, a page editing process can be performed in physical page units in the middle of performing printing control (printing process) based on the printing data from the application 101.

### Sixth Embodiment

Next, a printing control process using the host computer 10 according to the sixth embodiment of the present invention is described.

In the printing control process using the host computer 10 according to the sixth embodiment of the present invention, a page editing operation in logical page units or in physical page units is performed in the page viewer 110. That is, the host computer 10 performs page editing operation described in the fourth embodiment of the present invention when the user requests for a page editing operation in logical page units by using the keyboard 57, and performs page editing operation described in the fifth embodiment of the present invention when the user requests for a page editing operation in physical page units by using the keyboard 57. Furthermore, other operations performed together with the page editing operations of the fourth and fifth embodiments are also performed.

In the sixth embodiment of the present invention, provisional printing data (provisional printing files) are generated logical page by logical page based on the printing data from the application 101, and the depiction data items (page objects) corresponding to the provisional printing data (provisional printing files) are displayed physical page by physical page (alternatively, displayed logical page by logical page) on the display apparatus 55. This allows the user to visually confirm the layout of a page on which the printing data are printed and edit the depiction data item displayed on the display apparatus 55. Thus, when the depiction data item (page object) is edited in logical page units or in physical page units, the provisional printing data corresponding to the edited the depiction data can be edited. Accordingly, a page editing process can be performed in logical page units in the middle of performing printing control (printing process) based on the printing data from the application 101.

Further, the present invention is not limited to these embodiments, but variations and modifications may be made without departing from the scope of the present invention.

The present application is based on Japanese Priority Application No.2004-316673 filed on Oct. 29, 2004, with the Japanese Patent Office, the entire contents of which are hereby incorporated by reference.

What is claimed is:

1. A printing control apparatus for controlling an operation for printing printing data generated from an application, the printing control apparatus comprising:
a printing data file generating part for generating one or more printing data files for each page based on the printing data, each printing data file including a page object;
a page object displaying part for displaying the page object included in the printing data file;
a page editing part for editing the page object displayed by the page object displaying part; and
a printing data file editing part for editing the printing data file corresponding to the page object edited by the page editing part.

2. The printing control apparatus as claimed in claim 1, wherein the printing data file editing part includes
an associating part for associating a page index with respect to the printing data file and the page object included in the printing data file,
a list generating part for generating a list indicating the order for displaying the page object of the printing data file,
a list changing part for changing the order indicated in the list generated by the list generating part, and
a printing data file changing part for changing the printing data file in accordance with the order changed by the list changing part,
wherein the list changing part is configured to change the order indicated in the list when the page editing part edits the page object by switching the page order of the page object.

3. The printing control apparatus as claimed in claim 1, wherein the printing data file editing part includes
an associating part for associating a page index with respect to the printing data file and the page object included in the printing data file,
a list generating part for generating a list indicating the order for displaying the page object of the printing data file,
a list changing part for changing the order indicated in the list generated by the list generating part, and
a printing data file changing part for changing the printing data file in accordance with the order changed by the list changing part,
wherein the list changing part is configured to change the order indicated in the list when the page editing part edits the page object by inserting a blank page between a page of one page object and a page of another page object.

4. The printing control apparatus as claimed in claim 1, wherein the page editing part is configured to edit the page object in correspondence with each logical page.

5. The printing control apparatus as claimed in claim 1, wherein the page editing part is configured to edit the page object in correspondence with each physical page.

6. The printing control apparatus as claimed in claim 1, wherein the page editing part is configured to edit the page object in correspondence with at least one of each logical page and each physical page.

7. A recording medium on which a program for causing a computer to execute a method for controlling an operation for printing printing data generated from an application, the program comprising:
a printing data file generating function for generating one or more printing data files for each page based on the printing data, each printing data file including a page object;
a page object displaying function for displaying the page object included in the printing data file;
a page editing function for editing the page object displayed by the page object displaying function; and
a printing data file editing function for editing the printing data file corresponding to the page object edited by the page editing function.

8. The recording medium as claimed in claim 7, wherein the printing data file editing function includes
an associating function for associating a page index with respect to the printing data file and the page object included in the printing data file,
a list generating function for generating a list indicating the order for displaying the page object of the printing data file,
a list changing function for changing the order indicated in the list generated by the list generating function, and
a printing data file changing function for changing the printing data file in accordance with the order changed by the list changing function,
wherein the list changing function is operable to change the order indicated in the list when the page editing function edits the page object by switching the page order of the page object.

9. The recording medium as claimed in claim 7, wherein the printing data file editing function includes
an associating function for associating a page index with respect to the printing data file and the page object included in the printing data file,
a list generating function for generating a list indicating the order for displaying the page object of the printing data file,
a list changing function for changing the order indicated in the list generated by the list generating function, and
a printing data file changing function for changing the printing data file in accordance with the order changed by the list changing function,
wherein the list changing function is operable to change the order indicated in the list when the page editing function edits the page object by inserting a blank page between a page of one page object and a page of another page object.

10. The recording medium as claimed in claim 7, wherein the page editing function is operable to edit the page object in correspondence with each logical page.

11. The recording medium as claimed in claim 7, wherein the page editing function is operable to edit the page object in correspondence with each physical page.

12. The recording medium as claimed in claim 7, wherein the page editing function is operable to edit the page object in correspondence with at least one of each logical page and each physical page.
